(19) United States
(12) Patent Application Publication
(10) Pub. No.: US 2003/0101093 A1
(43) Pub. Date: May 29, 2003

(54) System and method for measuring

(76) Inventors: Jill Susan Coomber, Surrey (GB); Susan Carolyn Grant, Surrey (GB)

Correspondence Address: BANNER & WITCOFF, 1001 G STREET N W, SUITE 1100, WASHINGTON, DC, 20001, US

(21) Appl. No.: 09/994,916

(22) Filed: Nov. 27, 2001

(51) Int. Cl. G06F 17/60

(52) U.S. Cl. 705/14; 705/10

(57) ABSTRACT

A method of measuring the effectiveness of at least one of public relations and marketing effort, said method comprising the steps of

i) defining a message array comprising a record relating to at least one message which it is desired to promote and a record of reports of the message,

ii) defining a deliverable array comprising record relating to at least one verifiable event selected from the group consisting of verifiable activities and verifiable outcomes and a record relating to an outcome deliverable,

iii) conducting at least one of public relations and marketing,

iv) monitoring for the at least one message,

v) updating the message array in response to detection of the at least one message,

vi) monitoring for an outcome deliverable, and

vii) updating said deliverable array in response to detection of an outcome deliverable.

### BACKGROUND OF THE INVENTION

This invention relates to a system and method for measuring. More especially but not exclusively this invention relates to a system and method for measuring the effectiveness of public relations (hereinafter “PR”) and marketing effort.

PR and marketing are very important in modern economic and political thought; consequently the PR and marketing industry is very large. However the effectiveness of the PR and marketing effort is measured all too infrequently, and objectively measured even less frequently: indeed a survey by the PR Consultants' Association in 1999 (UK) found a range of perceptions in the public mind, including “concealing/hiding truths”, “black art/mysterious” and “fluffy”.

One reason for these perceptions might be that it is hard to point to anything that PR and communications actually produces; there is no tangible product to hold at the end of the day. Another reason is that the current lack of measurability means it is entirely conceivable that considerable effort may not generate any desired outcome, yet PR practitioners fail to take steps to measure their activity to prove the link between effort and results.

### SUMMARY OF THE INVENTION

The invention seeks to provide at least semi-quantitative measures of the effectiveness of PR and marketing effort.

According to the invention there is provided a method of measuring the effectiveness of at least one of public relations and marketing effort, said method comprising the steps of

i) defining a message array comprising at least one message which it is desired to promote,

ii) defining a deliverable array comprising at least one verifiable event selected from the group consisting of verifiable activities and verifiable outcomes,

iii) conducting at least one of public relations and marketing,

iv) monitoring for verifiable activities and verifiable outcomes,

v) updating said deliverable array in response to detection of verifiable activities and outcomes detected in step iv).

According to the invention there is further provided a system for measuring the effectiveness of at least one of public relations and marketing effort, said system comprising

i) a message array comprising at least one message which it is desired to promote,

ii) a deliverable array comprising at least one verifiable event selected from the group consisting of verifiable activities and verifiable outcomes,

iii) a monitor monitoring for verifiable activities and verifiable outcomes resulting from public relations or marketing,

iv) an updater updating said deliverable array in response to detection of verifiable activities and outcomes detected in step iii).

According to an embodiment of the invention there is provided a method of measuring the effectiveness of at least one of public relations and marketing effort, said method comprising the steps of

i) defining a message array comprising a record relating to at least one message which it is desired to promote and a record of reports of the message,

ii) defining a deliverable array comprising record relating to at least one verifiable event selected from the group consisting of verifiable activities and verifiable outcomes and a record relating to an outcome deliverable,

iii) conducting at least one of public relations and marketing,

iv) monitoring for the at least one message,

v) updating the message array in response to detection of the at least one message,

vi) monitoring for an outcome deliverable, and

vii) updating said deliverable array in response to detection of an outcome deliverable.

The said record of reports of the message may further comprise a record of a date of publication of the message. A target audience array may be associated with the message array, the target audience array correlating each of a plurality of messages with target audiences. The outcome deliverable can include a record of the date of the outcome deliverable. At least one metric array can be provided said metric array providing an at least semi-quantitative measure of records of reports of the message. A metric array can comprise a measure of the length of the report of the message. A metric array can comprise a measure of the source of the reported message. A metric array can comprise a measure of the tone of the reported message.

Some embodiments of the invention provide a system, for example a computer based system for measuring the effectiveness of at least one of public relations and marketing effort, said system comprising

i) a message array comprising a record relating to at least one message which it is desired to promote and a record of reports of the message,

ii) a deliverable array comprising record relating to at least one verifiable event selected from the group consisting of verifiable activities and verifiable outcomes and a record relating to an outcome deliverable,

iii) a first monitor monitoring for the at least one message resulting from public relations or marketing,

iv) a first updater updating the message array in response to detection of the at least one message,

v) a second monitor monitoring for an outcome deliverable, and

vi) a second updater updating said deliverable array in response to detection of an outcome deliverable.

### BRIEF DESCRIPTION OF THE DRAWINGS

The invention will be further explained by way of example by reference to the accompanying figures of which:

FIG. 1 is a block diagram of a system of use in the invention;

FIG. 2 is a flow chart of the invention in use;

FIG. 3 is a view of a message array;

FIG. 4 is a view of a deliverable array;

FIG. 5 is a view of metric array showing the number of articles detected categorised by length and type;

FIG. 6 is a view of a metric array showing articles detected categorised by content;

FIG. 7 is a view of a metric array showing articles detected categorised by tone;

FIG. 8 is a view of a graph showing progress towards activity deliverables;

FIG. 9 is a further graph showing progress towards activity deliverables;

FIG. 10 is a representation of overall coverage progress both with and without unattributables compared with target;

FIG. 11 is a view of a metric array showing detected articles categorised by type; and

FIG. 12 is a section extending over several sheets of a report showing the source of coverage and activity.

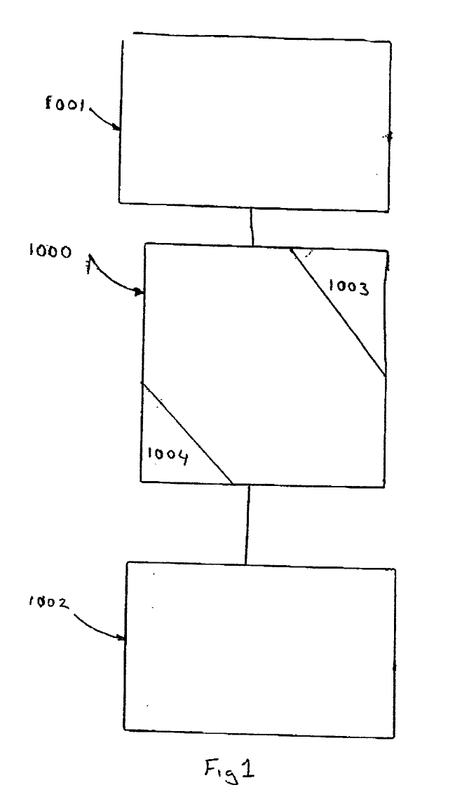

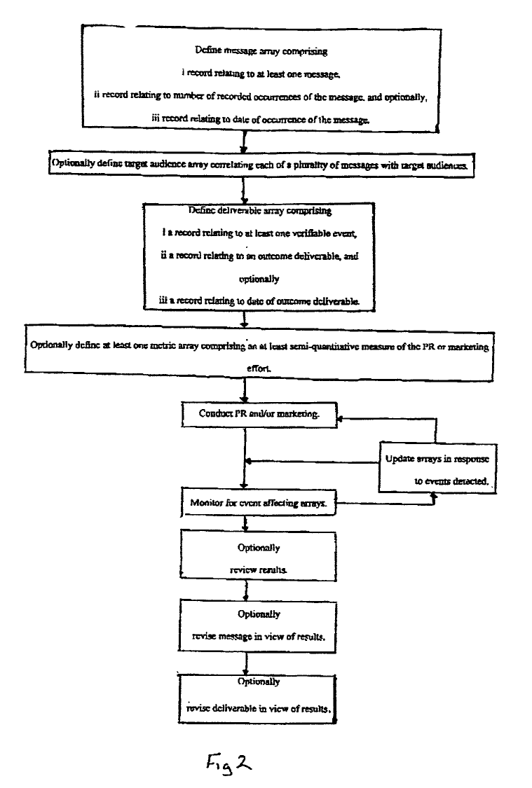

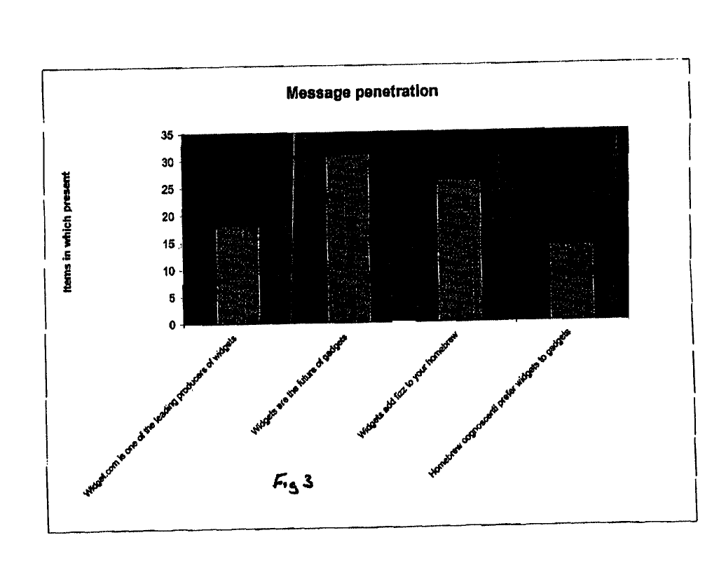

In PR, an early and important step is to define which message or messages it is desired to promote. While care should be taken not to define too many messages to avoid confusion, a plurality of messages may be promoted. In some embodiments of the invention, at least some of a plurality of messages may be intended for direction to a plurality of sub-audiences. By way of example, the message that a product is a high profit margin, one is a message of considerable positive interest to retailers but a neutral or negative one to purchasers. By way of a further and topical example, the message that a political party wishes to ban or restrict the availability of firearms is of strong positive interest to certain sectors of the community. The same message would have a strong negative impact with other sectors. The political party might therefore wish to convey a strong anti-firearm message to the media likely to be accessed by those receptive to such a message but to spend less effort promoting that message to media likely to be accessed by those on whom the message could have an alienating impact.

The messages can conveniently be set out in a first, message, array. The message array like the other arrays to be described hereinafter can be an array of cells in a spreadsheet. Those skilled in the art will have no difficulty in devising suitable ways of producing the arrays. In preferred embodiments, the invention is embodied in a conventional computer spreadsheet such as MICROSOFT EXCEL.

The invention is illustrated herein by reference to a hypothetical product trademarked WIDGET competing with a current market leader trademarked GADGET. The illustration is purely hypothetical and no connection between any real product or service is intended.

The message array therefore comprises one or more messages which it is intended to promote. Optionally associated with at least some entries in the message array is a target audience. A target audience array may be provided, for example in the described embodiment including trade press and consumer orientated media. The target audience is not shown in physical juxtaposition with the message array but if desired, the target audience array could be cells of the message array. In the illustrated embodiment the message array of FIG. 3 also includes information about the number of times each message has been detected. This information may be an aggregate since the campaign began or may be over particular periods for example calendar months. In the latter case it may be desirable to provide a plurality of copies of the message array each for a different period.

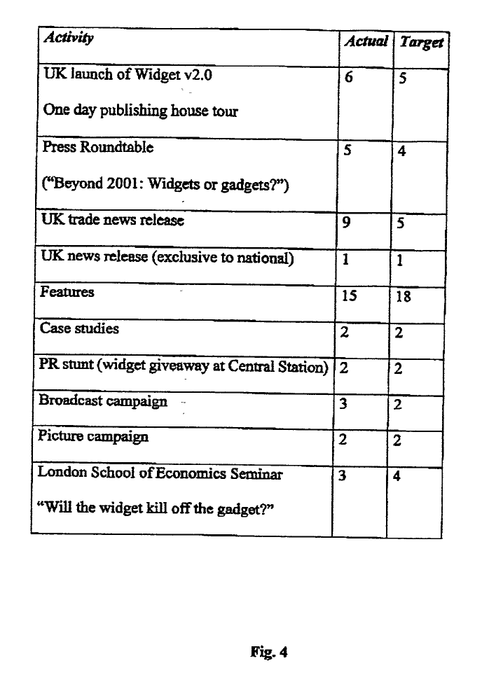

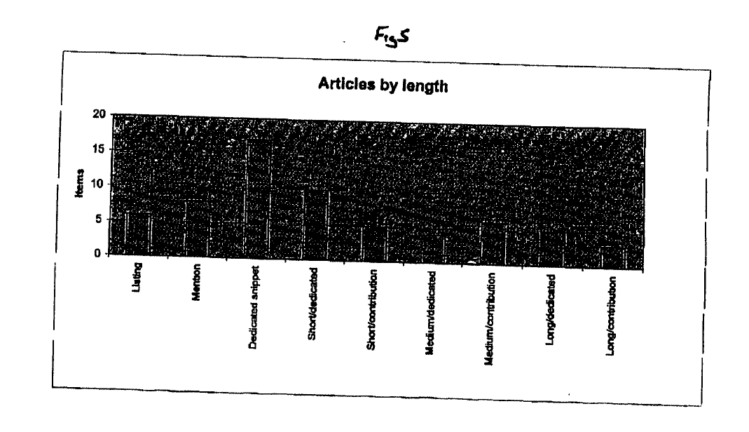

A deliverable array is defined. A deliverable is, for the purposes of the invention, defined as a verifiable, desired activity (hereinafter “activity deliverable”), or a verifiable, desired outcome from an activity (hereinafter “outcome deliverable”). The list of possible verifiable activity deliverables is nearly only limited by the imagination of the PR or marketing consultants. Examples include news conferences, press releases, publications, calls to call centres, relative stock price performance, giveaways and seminars. Associated with each class of event in the deliverable array is an outcome deliverable. The outcome deliverable is a measure of achievement of the activity deliverable and may for example be the securing of a number of items of media coverage or the securing of attendance of a number of journalists at an event or an increase by 5% in the number of calls to a call center. The deliverable array may be and preferably is multidimensional with a plurality of ‘layers’ each corresponding to a time period for example a calendar month to reflect the need for various deliverables to be achieved at different stages of the campaign. In the illustrated embodiment at FIG. 4 cells are provided for the total number of a particular type of deliverable achieved. In the illustrated embodiment cells are provided for the total number of a particular type of deliverable which it is sought to achieve together with cells for the number actually achieved to date.

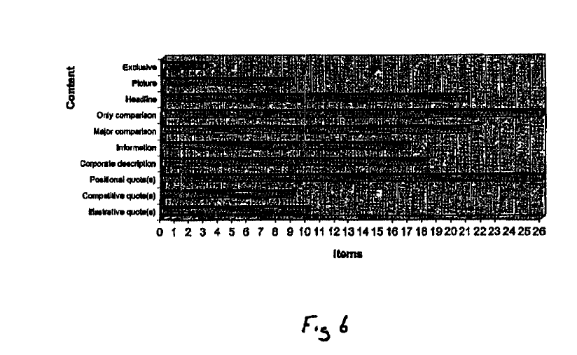

Like farm animals, not all mentions are equal and desirably a plurality of metrics arrays, as shown in FIGS. 5, 6 and 7, providing at least a semi-quantitative measure of the mention are provided. In the illustrated embodiment, FIG. 5, there is a length array where the length and type of the mention for example dedicated or contributed, short or long are specified. A quantitative message of length can be defined. In the illustrated embodiment there is further provided a type array with the possible classification ranging from listing to opinion. Still further in the illustrated embodiment there is provided a contribution array, FIG. 6. In the illustrated embodiment, this ranges from “illustrative quote” to “exclusive”. One interesting and important kind of mention is one which can not be traced to the PR or marketing effort. This kind of mention is important because not only is it “free publicity” but also it indicates that public awareness of the client's goods or service is increasing.

Note that all of these metrics can be customised by a user of the invention. Using for example the metric regarding the length of a mention, a company such as Microsoft for which media coverage is entirely normal may regard as “short” any item of media coverage in which it is mentioned where the length of the item is less than 500 words, while a newly-launched company of 5 employees for which press coverage is a luxury may consider this to be “very long”.

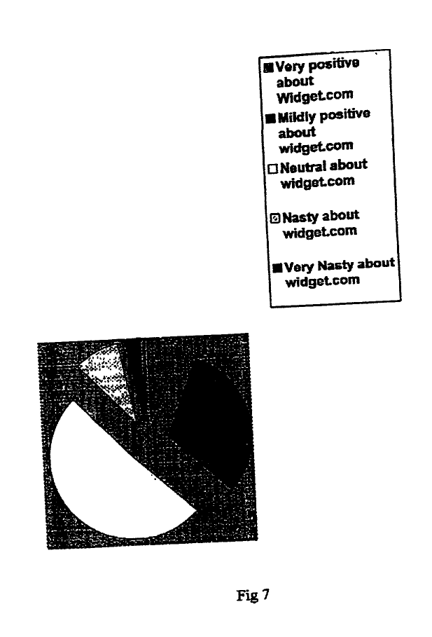

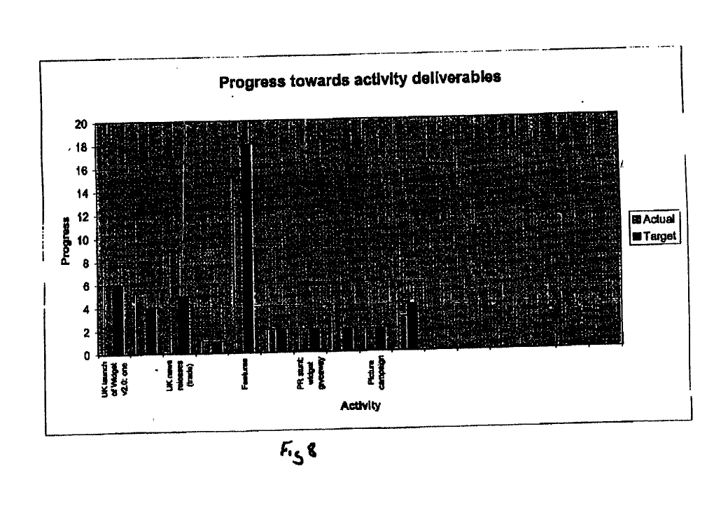

Yet further in the illustrated embodiment there is provided a tone array as shown in FIG. 7. The tone array tends to be somewhat subjective in that what one reader regards as very positive a second reader may perceive as mildly positive. It is unlikely, but not impossible, however that what one reader perceives as very positive a further reader perceives as very negative. The subjective nature of the tone array entries can be reduced be having a panel of readers vote on the tone.

As previously mentioned not all media sectors are as important to some groups as others are. A critical opinion article in the WALL STREET JOURNAL may be the result of considerable greater intellectual effort than a short uncritical review in the NATIONAL ENQUIRER but if the target audience read the latter publication rather than the former then the second piece will be more valuable than the first.

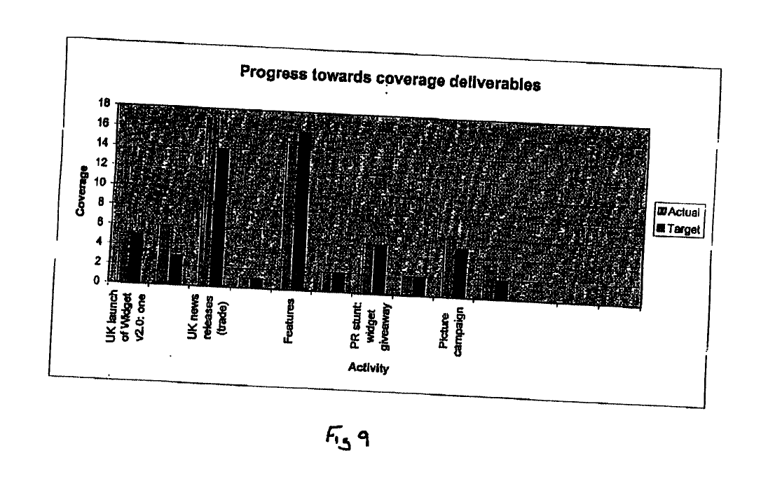

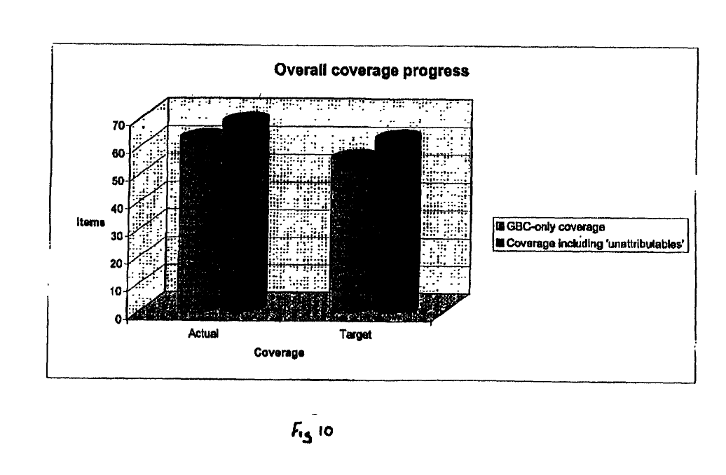

The PR or marketing effort can then begin in conventional manner. As a target is achieved, an entry can be made in the requisite cell of the deliverable array in the worksheet associated with the month in which the activity deliverable occurred. As time passes it becomes possible to graph the progress which helps visualise the progress made and allow for refinement of the PR or marketing strategy. For example, FIG. 8 shows a graph of progress towards activity deliverables where substantially all targets have been exceeded. In these circumstances, one could imagine a success fee being negotiated by the PR or marketing consultants and/or a reduction in the effort expended. FIG. 9 shows a graph of progress towards coverage deliverable in which UK trade news releases have exceeded the target while features have not reached the target. Again, strategy can be modified in view of this and negotiations may take place between the client and the consultant. For example, time and effort allocations could be modified. Alternatively or additionally, the client and consultant could engage in a dialogue in which the consultant's targets are modified.

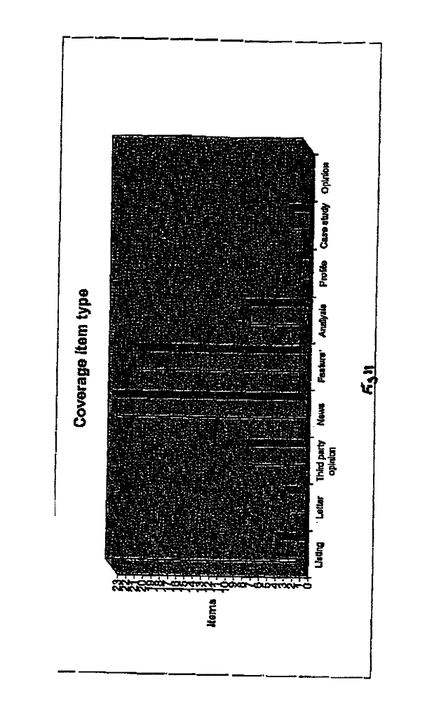

Overall coverage progress could be visualised as shown in FIG. 10 which compares target coverage both with and without unattributable outcome deliverables with that actually achieved. The media in which publication has been achieved can be visualised graphically optionally in conjunction with the target. Similarly as shown in FIG. 7 a graphical representation of the tone of the published material can be produced. In this case generally a comparison with the desired result is not provided since the desired

One axis of the report can include the source of coverage for example an article in the press while the other axis comprises information relating to the results therefore for example a feature article of generally positive tone. In general a report of this kind will include a row giving a total for each activity. In the present case it has been omitted for the purposes of brevity.

It will be further apparent that the invention is useful to PR and marketing organisations in obtaining information about how effective the organisation as a group and the members thereof are at various kinds of PR and marketing.

The invention can be physically embodied in a computer such as a PC or APPLE® comprising a processing unit 1000, connected to a display unit 1001 such as a VDU and/or printer, and a data entry unit such as a keyboard 1002. The processing unit contains at least one processor 1003, together with a plurality of data storage locations 1004. Storage locations 1004 contain the arrays together with instructions instructing the processing unit to process information stored in the arrays as hereinbefore described.

result is generally that the tone be as positive as possible. In some embodiments, however, the tone could be compared with the tone of previous campaigns.

In at least some embodiments of the invention a graphical representation of the number of articles against their length is generated as shown in FIG. 5. In general, one tends to see a gaussian type curve. Since longer articles are usually perceived to be of high quality successive campaigns can seek to drive the mode further to the right. Still further graphical representations of for example coverage item type as shown in FIG. 10 and coverage content can be produced. An optional but preferred graphical representation is that shown in FIG. 3 which shows message penetration and allows easier comprehension of how frequently the messages have appeared and therefore a likely measure of their penetration into the market's consciousness. Clearly a low message penetration indicates that either the message is deemed irrelevant or inappropriate by the audience, or that the strategy and tactics intended to deliver the message is failing or has been carried out inadequately.

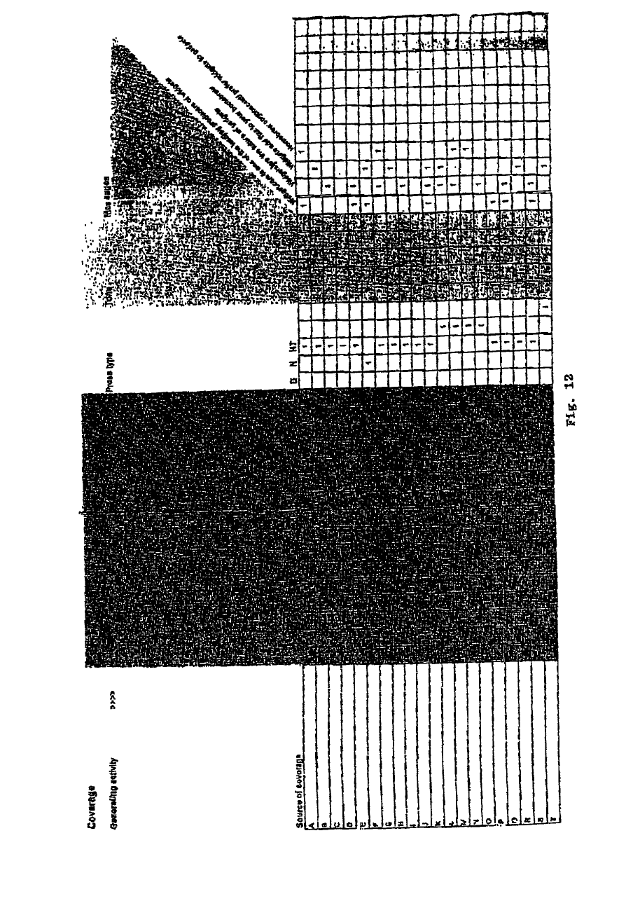

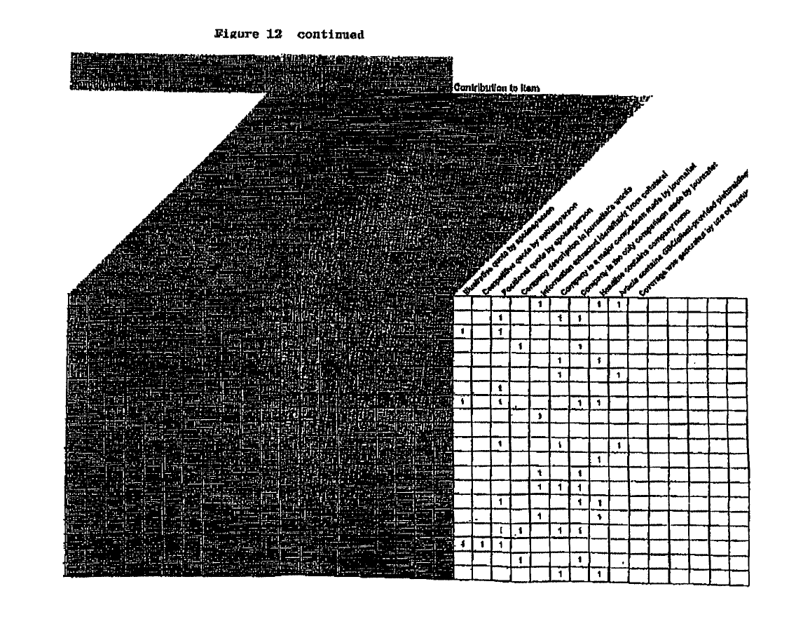

As shown in FIG. 12 (which comprises a section only on the ground of brevity) a more or less comprehensive report which again may be divided into a plurality of worksheets based on time intervals can be produced.

What we claim is:

1. A method of measuring the effectiveness of at least one of public relations and marketing effort, said method comprising the steps of
i) defining a message array comprising a record relating to at least one message which it is desired to promote and a record of reports of the message,
ii) defining a deliverable array comprising record relating to at least one verifiable event selected from the group consisting of verifiable activities and verifiable outcomes and a record relating to an outcome deliverable,
iii) conducting at least one of public relations and marketing,
iv) monitoring for the at least one message,
v) updating the message array in response to detection of the at least one message,
vi) monitoring for an outcome deliverable, and
vii) updating said deliverable array in response to detection of an outcome deliverable.

2. The method of claim 1 wherein said record of reports of the message further comprise a record of a date of publication of the message.

3. The method of claim 1 wherein a target audience array is associated with the message array, the target audience array correlating each of a plurality of messages with target audiences.

4. The method of claim 1 wherein the record of the outcome deliverable includes a record of the date of the outcome deliverable.

5. The method of claim 1 wherein at least one metric array is provided said metric array providing an at least semi-quantitative measure of records of reports of the message.

6. The method of claim 5 wherein a metric array comprises a measure of the length of the report of the message.

7. The method of claim 5 wherein a metric array comprises a measure of the source of the reported message.

8. The method of claim 5 wherein a metric array comprises a measure of the tone of the reported message.

9. A system for measuring the effectiveness of at least one of public relations and marketing effort, said system comprising
i) a message array comprising a record relating to at least one message which it is desired to promote and a record of reports of the message,
ii) a deliverable array comprising record relating to at least one verifiable event selected from the group consisting of verifiable activities and verifiable outcomes and a record relating to an outcome deliverable,
iii) a first monitor monitoring for the at least one message resulting from public relations or marketing,
iv) a first updater updating the message array in response to detection of the at least one message,
v) a second monitor monitoring for an outcome deliverable, and
vi) a second updater updating said deliverable array in response to detection of an outcome deliverable.

10. The system of claim 9 wherein said record of reports of the message further comprise a record of a date of publication of the message.

11. The system of claim 9 wherein a target audience array is associated with the message array, the target audience array correlating each of a plurality of messages with target audiences.

12. The system of claim 9 wherein the record of the outcome deliverable includes a record of the date of the outcome deliverable.

13. The system of claim 9 wherein at least one metric array is provided said metric array providing an at least semi-quantitative measure of records of reports of the message.

14. The system of claim 13 wherein a metric array comprises a measure of the length of the report of the message.

15. The system of claim 13 wherein a metric array comprises a measure of the source of the reported message.

16. The system of claim 13 wherein a metric array comprises a measure of the tone of the reported message.
